(19) United States
(12) Patent Application Publication
(10) Pub. No.: US 2015/0320253 A1
(43) Pub. Date: Nov. 12, 2015

(54) EGG COOKER

(71) Applicant: Yongkang Huitian Electrical Appliance Co., Ltd., Yongkang (CN)

(72) Inventors: Xiaocun Hu, Yongkang (CN); BaoBao Xu, Yongkang (CN)

(21) Appl. No.: 14/125,053

(22) PCT Filed: Aug. 9, 2013
(86) PCT No.: PCT/CN2013/081139

§ 371 Date: Dec. 9, 2013

(51) Int. Cl. A47J 29/02

(52) U.S. Cl. CPC A47J 29/02

(57) ABSTRACT

The invention relates to an egg cooker. The egg cooker comprises a housing with mouth upwards; an inner container made of thermally conductive material, wherein the inner container is equipped in the housing in an approximately upright direction, having a cavity with mouth upwards so as to hold food material; PTC heating element, equipped on the inner container, wherein the PTC heating element will generate enough heat energy upon being connected to power supply and can transfer such heat energy to inner container (20) so as to cook the food material therein. The invention has following advantages: the foods cooked with the egg cooker shall be slender, and easy to eat, and the egg cooker is simple to operate, saving many troubles and being suitable for extensive application.

### TECHNICAL FIELD

The invention relates to a food cooker, especially for egg.

### BACKGROUND OF THE INVENTION

Now, people have many kinds of kitchenware to cook food, like basin, pot and pan. Usually, put the food to be cooked in a cooking container first, then put the container on stove, electromagnetic oven and other heating appliances, and take them out of such appliances and get the food in bowl or dish upon completion of the whole cooking procedure. Generally speaking, this cooking method can make kinds of foods but cannot make the food in a specific customizable shape.

If there is one cooker which can make different kinds of foods to a special customized shape, it shall be very popular with both home and restaurant. In reality, hot dog, sausage and similar foods are well-received in many countries, which is because of not only their taste but also their slender shape as this will make it easy to hold and eat without the need to use knife, fork or other tableware. Undoubtedly, the machine that needs neither cooking experience and skills nor needs to be attended during cooking procedure and can make foods in a specific size and shape shall enjoy great popularity.

The following shall introduce this kind of cooker, which can cook both a single kind of food material but also the mixture of multiple kinds of food materials in liquid, paste or solid, such as the egg wash or the mixture of egg wash and vegetables, meat and other food materials. Since egg wash as a main kind of food material in application can be mixed with other many kinds of food materials to form egg paste being easy to shape, the cooker is called egg cooker.

### SUMMARY OF THE INVENTION

The invention aims to provide a machine to make slender-shaped food, so as to solve the problem of un-customizable food shape and complicated cooking procedure.

A technical solution employed for solving the aforementioned problem is that: a kind of egg cooker, comprising:

A housing with mouth upwards;

Inner container, made of thermally conductive material, is equipped in the said housing in an approximately upright direction, having a cavity with mouth upwards, which is used to hold food material;

PTC heating element, is equipped on the inner container, can generate enough heat energy upon being connected to power supply and transfer such heat energy to inner container so as to cook the food material therein.

The technical solution's design philosophy is that: PTC heating element is of the characteristic of keeping constant temperature automatically so that the temperature shall never exceed the predetermined temperature limit even without a temperature control system by controlling the temperature using the PTC heating element. The only thing left to do is to connect PTC heating element to power supply; as the PTC heating element has a wide working voltage spectrum and a strong adaptability and is not easy to be damaged, the surface temperature shall have minor change even if the working voltage varies by two times; when PTC heating element is used to heat liquid (like water), it shall not be damaged and can still work reliably even if the liquid is dried out; besides, even if any liquid is splashed on the PTC heating element accidently, the egg cooker shall not be damaged.

The egg cooker employs vertical baking technology. After egg wash or other food materials is put in it, as temperature rises, the bottom of the food material may generate enough pressure to enable the shaped food to rise. Because the column-shaped food shall come out of the inner container at least partially, the delicious food can be enjoyed by using a bamboo stick only. Certainly, any ingredient can be added to make various snacks of great look, aroma and taste. The egg cooker's inner container can apply the section of diverse shapes, like round, polygon, heart shape, so that the food shape can be customized. Moreover, the egg cooker can be used to bake non-liquid composite food materials such as meat, vegetables and so on. It should be noted that as the inner wall of inner container can be contacted closely, when it is used to cook meat, vegetables or the like, the thoroughly cooked foods shall not rise automatically and must be taken out by pouring out or manually.

Advantageously, the PTC heating element has a maximum predetermined temperature of up to 80-150° C. Within the limited temperature range, the egg cooker can not only cook the food materials thoroughly but also make such thoroughly cooked egg wash or similar food materials rise automatically.

Advantageously, the PTC heating element is of PTC heat-sensitive porcelain heating plate. Advantageously, the PTC heating element stretches towards the axial direction of inner container so that the inner container can be heated integrally and evenly as well as efficiently.

Advantageously, the power supply input terminal of the PTC heating element is equipped with a thermal fuse, which serves to add an overheating protection function so that when the egg cooker's temperature reaches the predetermined temperature limit owing to a malfunction, the power shall be disconnected automatically to avoid any contingency.

Advantageously, a heat insulation layer exists between the housing and the inner container. Advantageously, the ratio of height and hole diameter of the cavity in the inner container is at least 1.5. The design aims to confine the inner container's size, as too small ratio shall result in difficulty in cooking the central part of the food material and thus it may take longer time to make the food materials fully cooked. Additionally, as the food material contacts inner wall of inner container closely with oil so that if the inner container has a too small height, the steam will run out gradually and in this case the liquid food material shall not rise easily.

Advantageously, the inner container has a cavity.

Advantageously, the top part of said housing and inner container connects with an annular cover, and the inner edge of the cover is aligned with the inner wall of the inner container while the outer edge of the cover is aligned with the outer wall of the housing.

Advantageously, the cover inclines down from outer edge to inner edge to form the shape of bellmouth.

Advantageously, the inner container has at least two cavities.

Advantageously, there is just one PTC heating element, but there are several cavities surrounding said cavity.

Advantageously, there are at least two PTC heating elements, so that they are arranged surrounding or being surrounded by or intersecting with several cavities, so as to heat the cavities evenly and efficiently.

Advantageously, the top part of said housing and inner container connects with an annular cover, and the outer edge of the cover is aligned with the outer wall of the housing; the cover has through-holes in the same number with that of cavities and such through-holes match with the cavities one to one, and the said through-holes are aligned with the side wall of the cavities.

Advantageously, the diameter of the through-holes decreases up to down so as to form the shape of bellmouth. The above introduces the egg cooker's structure design with one or more than one inner containers and one or more than one PTC heating elements.

Advantageously, there are at least two PTC heating elements, the said outer wall of the housing is equipped with a multifunction adjustment switch to control the ON or OFF of one or more than one of the PTC heating elements. The design is introduced to adjust the number of PTC heating elements used for heating through a multi-function switch, thus to generate different quantity of heat energy to cook different kinds of food materials, like egg, meat, vegetables and so on.

Advantageously, on the top of the cover there is a header to control the opening or closing of the mouth of the inner container.

The invention has advantages that: the egg cooker's inner container can apply the section of diverse shapes, like round, polygon, and heart shape, so that the foods cooked with the egg cooker shall be slender, and easy to eat. Meanwhile, the egg cooker is simple to operate, getting rid of many troubles.

### BRIEF DESCRIPTION OF DRAWINGS

FIG. 1 is the structure drawing of the egg cooker in Embodiment 1;

FIG. 2 is the structure drawing of the egg cooker in Embodiment 1 after removing the header;

FIG. 2 is exploded views of FIG. 2, omitting the heat insulation cotton therein;

FIG. 4 is the sectional view of FIG. 2;

FIGS. 5-7 are the drawings indicating the egg cooker's baking process;

FIG. 8 is the configuration drawing of the inner container, sleeve and PTC heating element in Embodiment 2;

FIG. 9 is the exploded views of the egg cooker in Embodiment 3 after removing the header, omitting the heat insulation cotton therein;

FIG. 10 is the configuration drawing of the inner container cavity and PTC heating element in Embodiment 4;

FIG. 11 is another configuration drawing of the inner container cavity and PTC heating element in Embodiment 4;

FIG. 12 is the structure drawing of the cover in Embodiment 4;

FIG. 13 is the outline structure drawing of the multiple cavities in Embodiment 4;

FIG. 14 is the configuration drawing of the multiple cavities and multiple PTC heating elements in Embodiment 5;

FIG. 15 is the structure drawing of the PTC heating element inserted in the bottom of inner container.

The marks in the drawings are respectively: 10: housing; 20: inner container; 21: sleeve; 30: PTC heating element; 40: cover; 50: thermal fuse; 60: header; 70: heat insulation cotton; 80: indicator; 90: multi-function adjustment switch.

### SPECIFIC EMBODIMENTS

Further description of the technical solution of present invention is set forth from the following embodiments with reference to the drawings.

### Embodiment 1

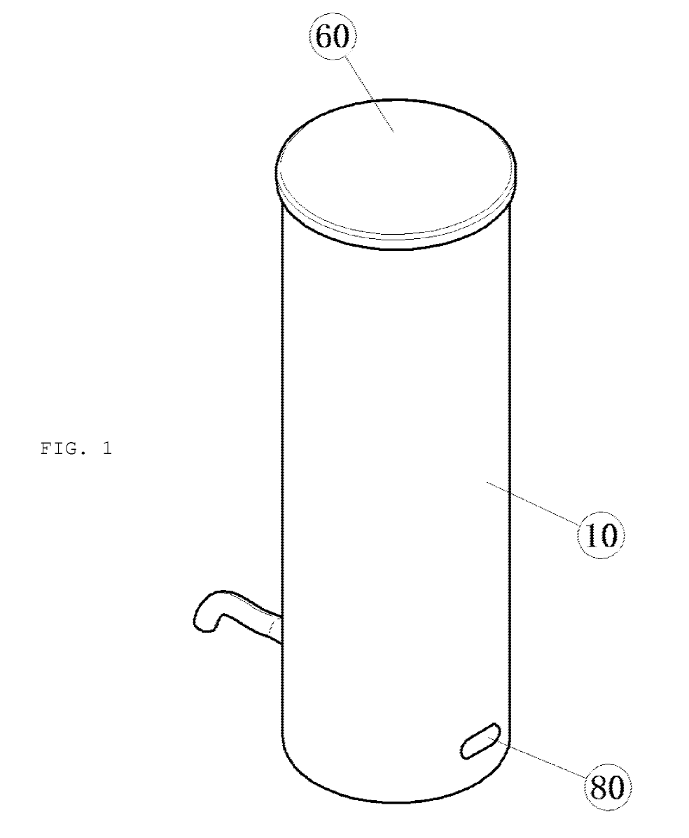

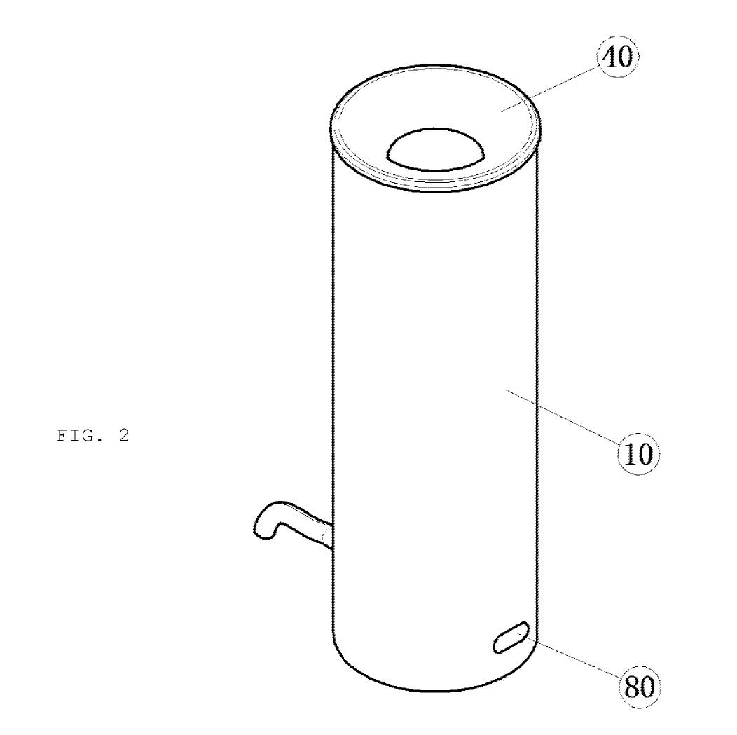

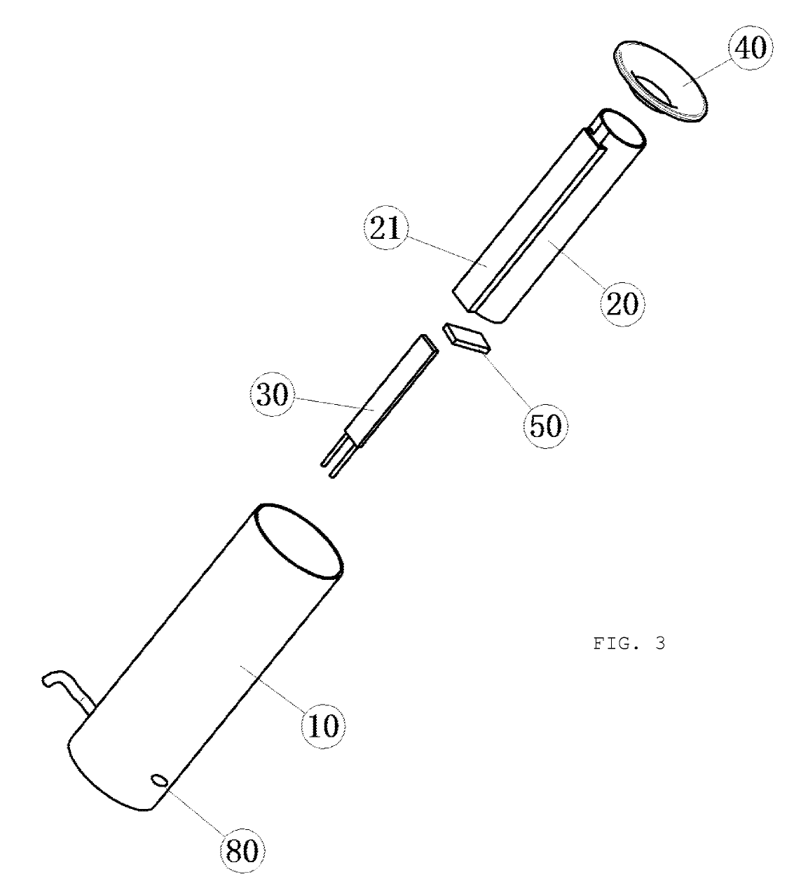

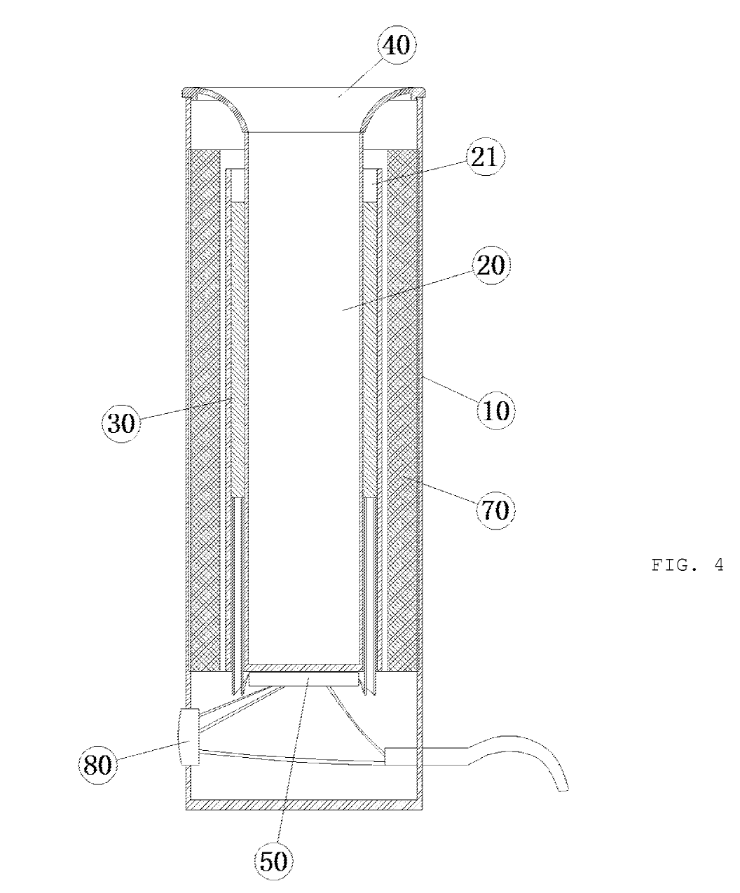

An egg cooker, as shown in FIGS. 1 through 4, comprising the housing 10 with mouth upwards; an inner container 20 is equipped in the housing 10; the ratio of the height of inner container 20′s cavity to its hole diameter is 5; heat insulation cotton 70 is equipped between the housing 10 and inner container 20, wrapping the outer wall of inner container 20; the inner container 20 is made of thermally conductive material, such as aluminum tube; said inner container 20 is equipped in the housing 10 in an substantially upright orientation and the inner container 20 has a cavity with mouth upwards, which is used to hold food material; on the outer wall of the inner container 20 there is a strip-shaped sleeve 21, and the longitudinal direction of the sleeve 21 stretches along the axial direction of inner container 20; PTC heating element 30 is inserted in the inner cavity of sleeve 21; said PTC heating element 30 is of PTC heat-sensitive porcelain heating plate, and has a maximum predetermined temperature of up to 120° C.; the top part of housing 10 and inner container 20 connects with an annular cover 40, and the inner edge of the cover 40 is aligned with inner wall of the inner container 20, while the outer edge of the cover 40 is aligned with outer wall of the housing 10; said cover inclines down from outer edge to inner edge to form the shape of bellmouth.

The said PTC heating element 30 is connected externally to power supply; the power supply input terminal of the PTC heating element is equipped with a thermal fuse 50; the PTC heating element 30 will generate enough heat energy upon being connected to power supply and can transfer such heat energy to inner container so as to cook the food material therein, and then it can generate enough pressure from the bottom of the food material to enable the shaped food to rise out of the inner container 20; on the top of the cover(40) there is a header 60 to control the opening or closing of the mouth of the inner container; remove the header 60 in use of the egg cooker, and cover it to prevent dust while not in use.

The indicator 80 is equipped on the bottom of outer wall of the housing 10 which is used to indicate the connection or breakage of power supply. As there is only one PTC heating element without other options, no power switch is equipped, and the only thing left to do is to plug or unplug the power connector.

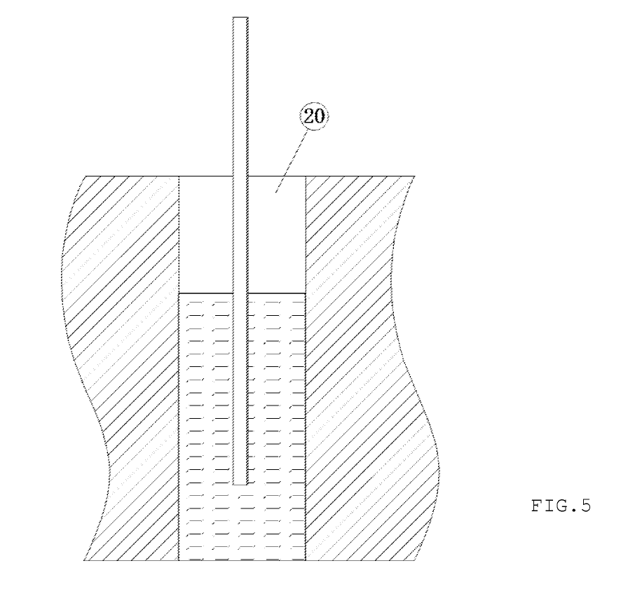

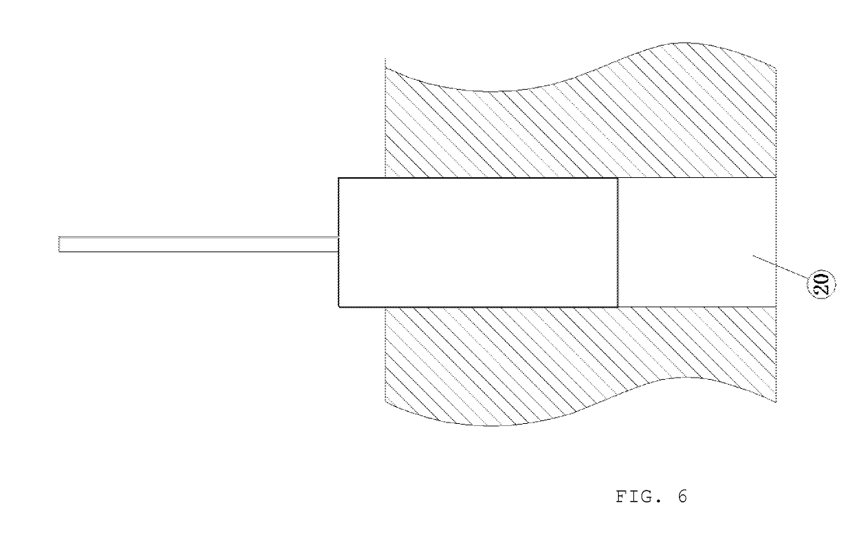

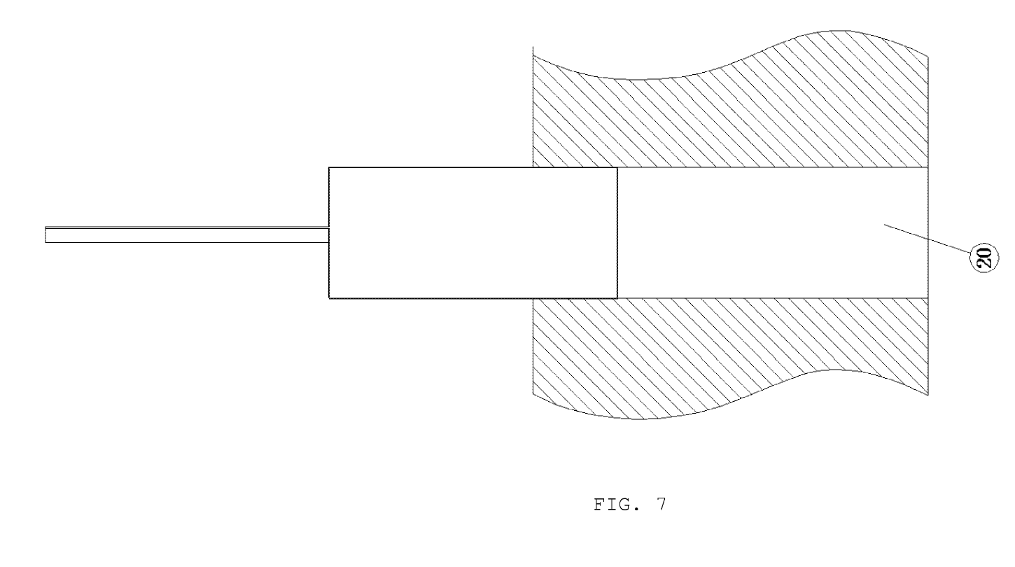

Usage method: Taking egg cooking for example, first, put the egg cooker on a flat surface, connect to power supply, then the indicator 80 will light up, which means the present device is started normally; preheat it for a while, spray edible oil in the inner container 20, then break one to two eggs in the inner container 20. If the eggs need to be fully cooked, it will take 6 to 8 minutes and generally the egg rolls will rise automatically as shown in FIGS. 5-7. Certainly, a bamboo stick can be inserted in the egg for convenient eating. If it fails to rise, pour it off or pick it up. If the eggs need to be half cooked, after cooking for 4 to 5 minutes, pour it off or pick it up directly.

### Embodiment 2

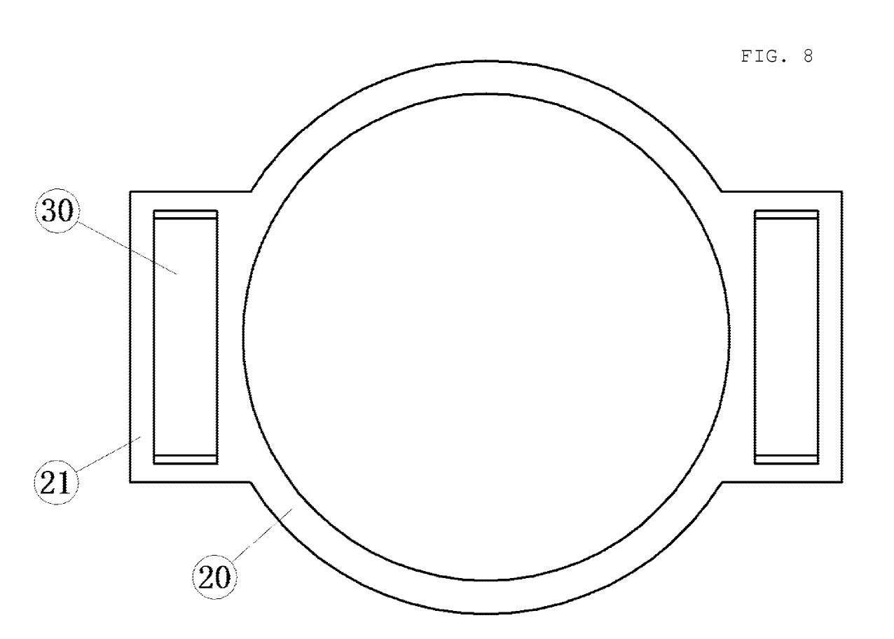

An egg cooker, and the difference between it and the one in Embodiment 1 is that: on the outer wall of the inner container 20 there are at least two strip-shaped sleeves, and these sleeves 21 are arranged around the outer wall of inner container 20. The Embodiment 2 only shows two sleeves 21 in symmetry in FIG. 8.

### Embodiment 3

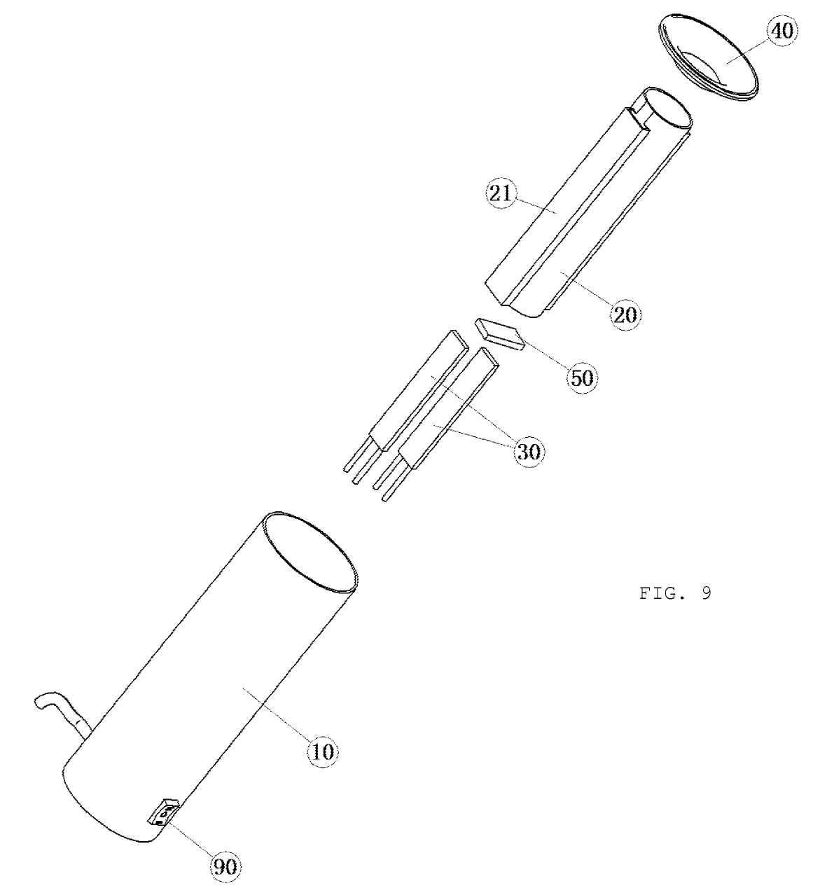

An egg cooker, and the difference between it and the one in Embodiment 2 is that: as Embodiment 2 indicates that it is allowed to set more than one sleeves 21, more heat energy shall be provided, and also because different food materials vary in demand for temperature and heat energy, in order to increase the options while cooking different food materials, a multi-function adjustment switch 90 is equipped in Embodiment 3, meanwhile the indicator 80 can be removed. Attached FIG. 9 shows a rocker switch, putting it in middle position shall disconnect the power supply, and dialing it down shall connect to a PTC heating element 30, and dialing it up shall connect to two PTC heating elements 30.

Embodiment 3 shows two gears adjustment; similarly, more PTC heating elements 30 can be increased with more adjustment buttons equipped.

### Embodiment 4

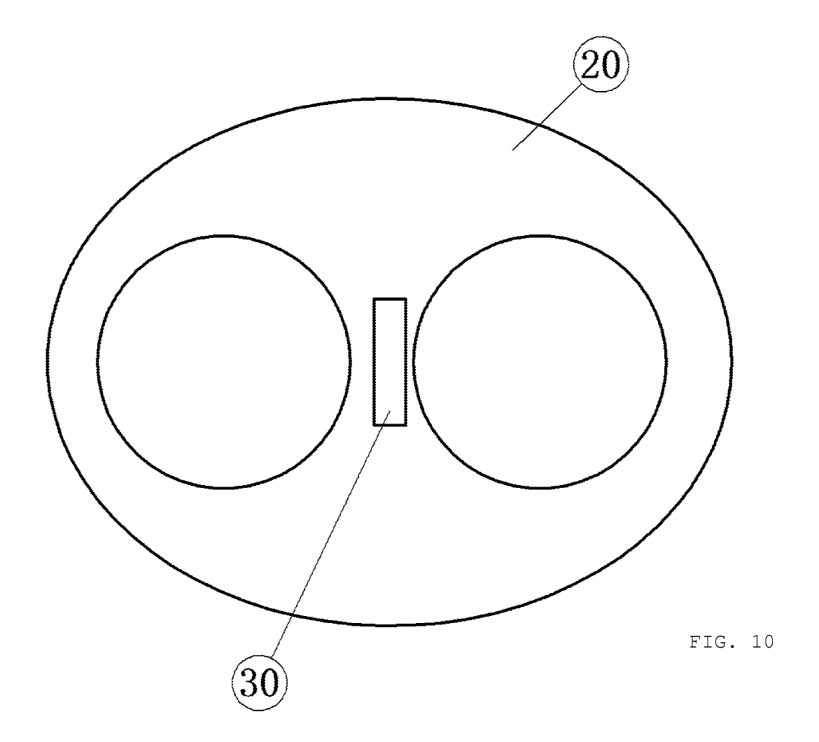

An egg cooker, and the difference between it and the one in Embodiment 1 is that: the inner container 20 has more than one, to be specific, at least two cavities as shown in FIG. 10. The sleeve 21 is situated between two cavities. Wherein, the middle through-hole in the inner container 20 is exactly the sleeve 21. The PTC heating element 30 is inserted in sleeve 21, and two cavities situate at two sides of the PTC heating elements and press it from both sides.

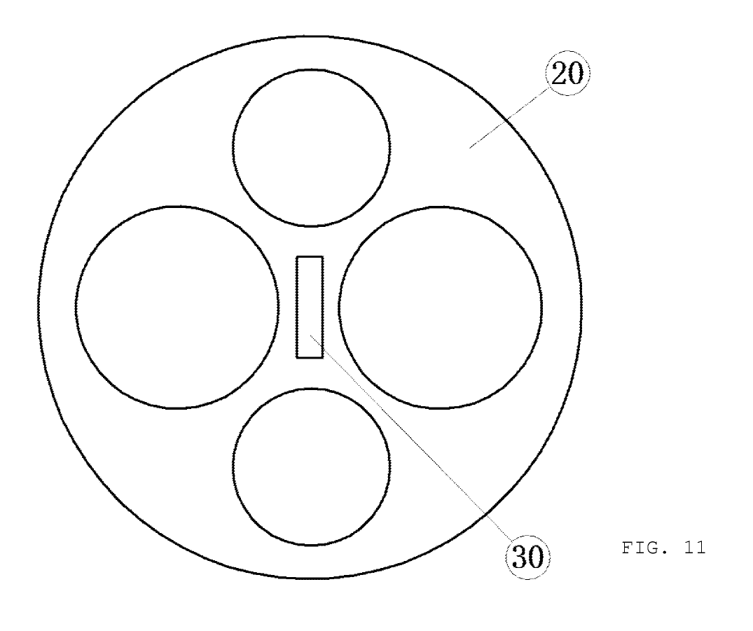

Similarly, when there are more than two cavities, like four, they shall be arranged around the PTC heating element 30 as shown in FIG. 11.

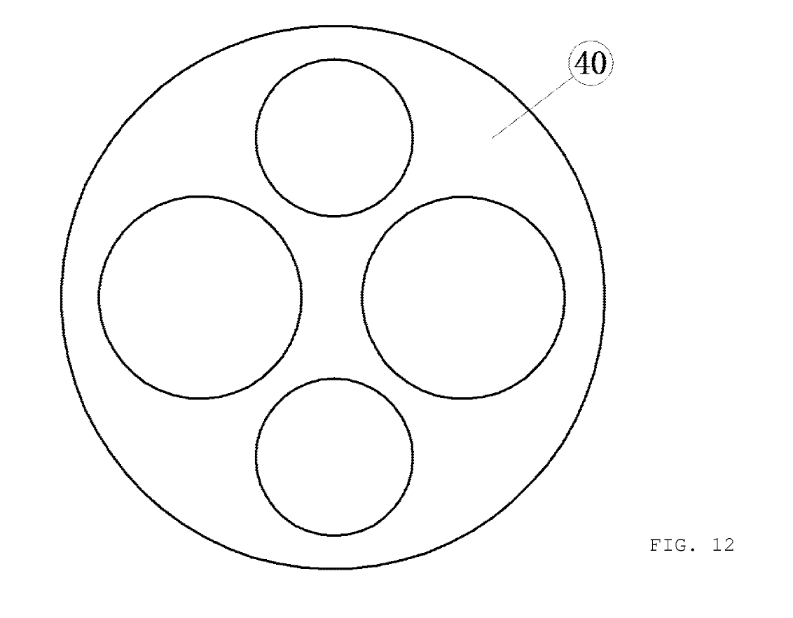

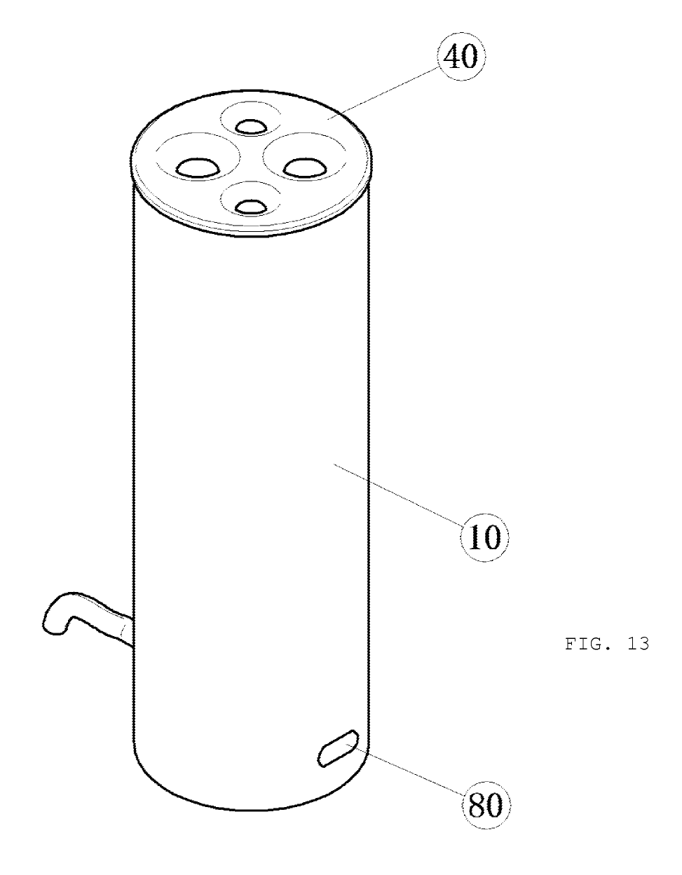

Accordingly, on the cover 40 there are through-holes in the same number with that of cavities as shown in FIG. 12 so that the through-holes are aligned with the side wall of the cavities. While adding food materials, to make liquid flow into the cavity easily but not left on the surface of cover 40, the diameter of the through-hole decreases up to down so as to form the shape of bellmouth as shown in the outline structure drawing FIG. 13.

### Embodiment 5

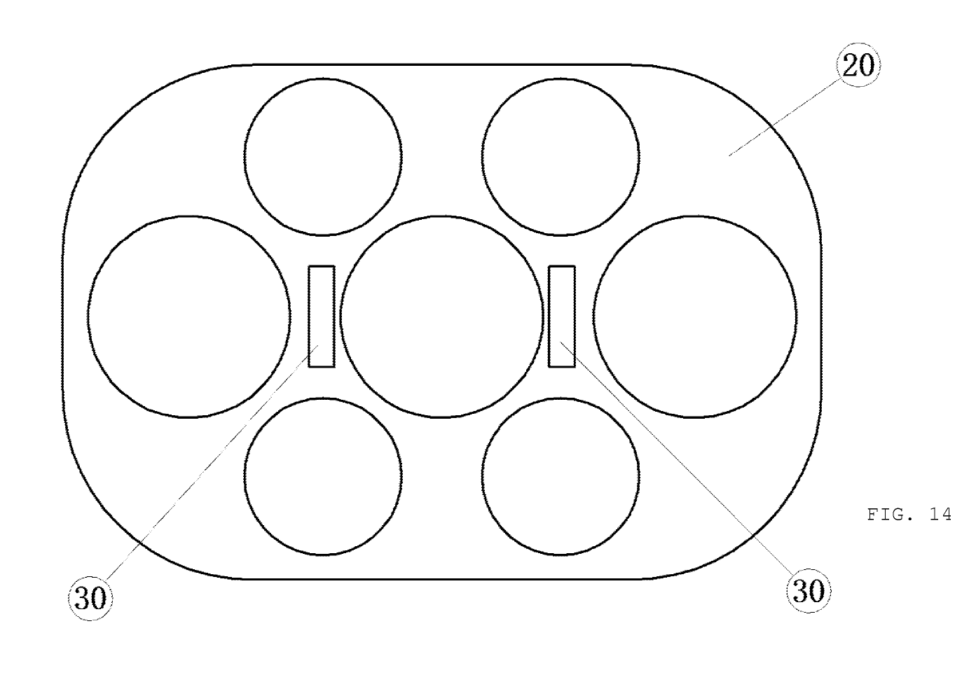

An egg cooker, and the difference between it and the one in Embodiment 4 is that: there are more than one, to be specific, at least two PTC heating elements 30. Embodiment 5 shows the configuration of multiple cavities and multiple heating plates, and these PTC heating elements 30 are arranged surrounding or being surrounded by or intersecting with the cavities, so as to heat the cavities evenly and efficiently. FIG. 14 shows the configuration structure of two PTC heating elements 30 and seven cavities. The present egg cooker can also be used for small dinner party.

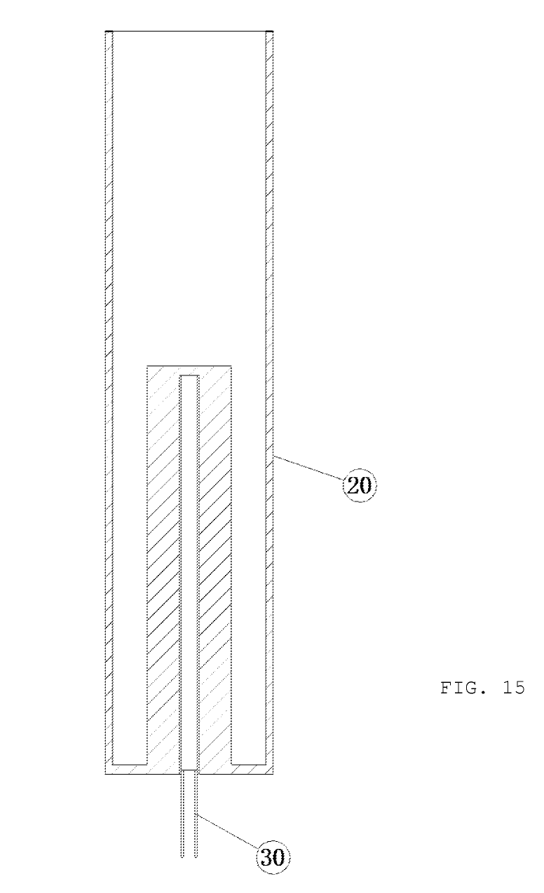

Additionally, groove can be furnished in bottom of the inner container 20, representing another form of sleeve 21. As shown in FIG. 15, the PTC heating elements shall be inserted in the groove.

The specific embodiments described above are only the illustration to preference embodiment examples of present invention. Any modification or supplement or similar substitution within the scope of the spirits and principles of the patent are all included in the protection scope required by the Claims of present invention.

1. An egg cooker, comprising:
Housing (10), referring to a housing (10) with mouth upwards;
Inner container (20), made of thermally conductive material, is equipped in the said housing (10) in an approximately upright direction. The inner container (20) has a cavity with mouth upwards so as to hold food material;
PTC heating element (30) is equipped on the inner container (20), and will generate enough heat energy upon being connected to power supply and can transfer such heat energy to inner container (20) so as to cook the food material therein.

2. The egg cooker as recited in claim 1, wherein the PTC heating element (30) has a maximum predetermined temperature of up to 80-150° C.

3. The egg cooker as recited in claim 1, wherein the PTC heating element (30) is of PTC heat-sensitive porcelain heating plate.

4. The egg cooker as recited in claim 1, wherein the PTC heating element (30) stretches towards the axial direction of inner container (20).

5. The egg cooker as recited in claim 1, wherein the power supply input terminal of the PTC heating element (30) is equipped with a thermal fuse (50).

6. The egg cooker as recited in claim 1, further comprising a heat insulation layer existed between the housing (10) and the inner container (20).

7. The egg cooker as recited in claim 1, wherein the ratio of height and hole diameter of the cavity in the inner container (20) shall be at least 1.5.

8. The egg cooker as recited in claim 1, wherein the inner container (20) has a cavity.

9. The egg cooker as recited in claims 8, wherein the top part of housing (10) and inner container (20) connects with an annular cover (40), and the inner edge of the cover (40) is aligned with inner wall of the inner container (20) while the outer edge of the cover (40) is aligned with the outer wall of the housing (10).

10. The egg cooker as recited in claims 9, wherein the cover (40) inclines down from outer edge to inner edge to form the shape of bellmouth.

11. The egg cooker as recited in claim 1, wherein the inner container (20) has at least two cavities.

12. The egg cooker as recited in claim 11, wherein there is just one PTC heating element (30), but around it there are several cavities.

13. The egg cooker as recited in claim 11, wherein there are at least two PTC heating elements (30), so that they are arranged surrounding or being surrounded by or intersecting with several cavities, so as to heat the cavities evenly and efficiently.

14. The egg cooker as recited in claim 11, wherein the top part of housing (10) and inner container (20) connects with an annular cover (40), and the outer edge of the cover (40) is aligned with the outer wall of the housing (10), the cover (40) has through-holes in the same number with that of cavities and such through-holes match with the cavities one to one, and the through-holes are aligned with the side wall of the cavities.

15. The egg cooker as recited in claim 14, wherein the diameter of the through-hole decreases up to down so as to form the shape of bellmouth.

16. The egg cooker as recited in claim 1, wherein there are at least two PTC heating elements (30), the outer wall of the housing (10) is equipped with a multifunction adjustment switch (90) to control the ON or OFF of one or more than one of the PTC heating elements (30).

17. The egg cooker as recited in claim 1, wherein on the top of the egg cooker there is a header (60) to control the opening or closing of the mouth of the inner container (20).
